(19) United States
(12) Patent Application Publication
(10) Pub. No.: US 2019/0073720 A1
(43) Pub. Date: Mar. 7, 2019

(54) PLATFORM, SYSTEM AND METHOD FOR DIAMOND TRADING

(71) Applicant: Ehud Yehuda TAL, Even Yehuda (IL)

(72) Inventor: Ehud Yehuda TAL, Even Yehuda (IL)

(21) Appl. No.: 16/180,904

(22) Filed: Nov. 5, 2018

Related U.S. Application Data
(63) Continuation-in-part of application No. 13/778,287, filed on Feb. 27, 2013, now abandoned.
(60) Provisional application No. 61/603,441, filed on Feb. 27, 2012.

(51) Int. Cl. G06Q 40/04; G06Q 20/40; G06Q 30/02

(52) U.S. Cl. CPC G06Q 40/04; G06Q 2220/00; G06Q 30/0283; G06Q 20/401

(57) ABSTRACT

A platform, system and method are herein provided to enable enhanced stone trading, the system including a stone listings data storage means, at least some of the stones being listed with a stone profile and a sell asking price; a stone buy requests data storage means; at least one pricing server including a pricing algorithm for calculating the real time estimated pricing of the listed stones; and at least one matching server including a matching algorithm for matching stone listings to stone buy requests, at least partially in accordance with the stone profile, asking price, user profile, trading history data, and estimated price, wherein at least one of the stone listing data storage means, stone buy requests data storage means, the pricing server or the matching server are cloud computing compatible, and wherein the stone listings, the buy requests and the real time estimated pricing are block-chained to enable transaction data to be resistant to modification.

### CROSS REFERENCE TO RELATED APPLICATIONS

This application is a Continuation-in-Part (CIP), claiming priority from U.S. patent application Ser. No. 13/778,287, filed Feb. 27, 2013, entitled “PLATFORM, SYSTEM AND METHOD FOR DIAMOND TRADING”, which claims priority from U.S. Provisional Patent Application No. 61/603,441, filed Feb. 27, 2012, entitled “PLATFORM, SYSTEM AND METHOD FOR DIAMOND TRADING”, both applications of which are incorporated in its entirety herein by reference.

### BACKGROUND

Currently, the vast majority of diamonds are traded hand to hand, between diamond businesses. More recently, diamond trading using electronic media has started to increase, but in general, act as an electronic billboard or list that may provide a way to search through a list of stones.

For almost a decade now the online diamond trading market generates millions of $US every year. This market is dominated by few websites that function primarily as online billboards allowing diamond traders to publish their diamond stocks and expose them to potential customers and partners. Such billboards generally allow for basic listing of diamonds by diamond holders, and searching for listed diamonds by potential traders.

### FIELD OF THE INVENTION

The present invention relates to systems and methods useful in online trading of stones. Specifically, embodiments of the present invention relate to systems, methods and devices that help optimize online trading of diamonds.

### SUMMARY OF THE INVENTION

A platform, system and method are herein provided to enable enhanced stone trading, the system including a stone listings data storage means, at least some of the stones being listed with a stone profile and a sell asking price; a stone buy requests data storage means; at least one pricing server including a pricing algorithm for calculating the real time estimated pricing of the listed stones; and at least one matching server including a matching algorithm for matching stone listings to stone buy requests, at least partially in accordance with the stone profile, asking price, user profile, trading history data, and estimated price, wherein at least one of the stone listing data storage means, stone buy requests data storage means, the pricing server or the matching server are cloud computing compatible.

In some embodiments, at least some of the stones may also include at least one actual deal price.

In some embodiments, the real time estimated pricing for a stone is adapted to provide a real time estimated pricing for a portfolio of stones.

In some embodiments, selected stones may be actively promoted, by being listed in an enhanced position in one or more marketing channels.

In some embodiments a stone matching mechanism is provided, for automatically matching two or more listed stones when such stones are determined by the system to have substantial similarity.

In some embodiments, a stone visual verification module is provided for enabling remote visual verification of a stone profile.

In some embodiments, one or more of stone listing changes, stone sell requests, stone buy request changes, stone promotion changes, stone matching changes, and stone verification changes may be automatically sent as an alert to a system user.

According to further embodiments, a database is provided that may include a listing of a users' stones for offer; a listing of a users' stones being requested; a listing of actual deal prices for stones that have been previously traded; and a listing of the trading history of a users' stones for offer and/or a user's stones being requested, wherein the database may be cloud computing compatible.

In some embodiments the database may be adapted to execute an algorithm for calculating one or more of personal stone trading report(s), indications of exposure of the user's stones, actual deal prices (ADP) of user's stones or other substantially similar stones, community generated feedback, user grading data, deal history data, market analysis data on user's stones or other substantially similar stones, stone pedigree data, and stone trading history data on user's stones or other substantially similar stones.

In some embodiments a Company management module may be provided for enabling interaction with Company related trade data.

In some embodiments a Broker management module may be provided for enabling interaction with Broker related trade data.

According to some embodiments, a method of trading stones online is provided, which may include listing one or more stones available for sale on a cloud computing compatible database, where the stones may be listed with a stone profile and a sell request price; listing one or more stones being requested for purchase, on the cloud computing compatible database, by a buyer; executing a pricing algorithm for calculating the real time estimated pricing of the listed stones, on a cloud computing compatible server; and executing a matching algorithm for matching stone listings to stone requests, at least partially in accordance with the real time estimated pricing, on the server.

In some embodiments the listing may also include one or more previous actual deal prices.

In some embodiments the method may include executing a stone valuation algorithm, for enabling automated valuing of stones in relation to stone characteristics, stone selling price and real demand prices.

In some embodiments the method may include automatically creating paired stones substantially in real time.

In some embodiments the method may automatically include sending list changes to a user.

In some embodiments the method may include sending an update to a user via a smart phone application.

In some embodiments the method may include executing a stone matching algorithm, for enabling automated matching of substantially similar stones.

In some embodiments the method may include photographing a stone by a seller holding a stone; and executing a stone verification algorithm, for enabling remote verification of a stone's characteristics.

In some embodiments the method may include promoting one or more selected stones on one or more promotion platforms using a pay for exposure type promotion methodology, optionally on an internal and/or external websites.

According to some embodiments, a blockchain powered stone trading system includes a stone listings data storage means, at least some of the stones being listed with a stone profile and an asking price; a stone buy requests data storage means; at least one pricing server including a pricing algorithm for calculating the real time estimated pricing of the listed stones; and at least one matching server including a matching algorithm for matching stone listings to stone buy requests; wherein at least one of the stone listing data storage means, stone buy requests data storage means, the pricing server or the matching server are cloud computing compatible, and wherein the stone listings, the buy requests and said real time estimated pricing are block-chained to enable transaction data to be resistant to modification.

In some embodiments, at least some of the stones may list an actual deal price.

In some embodiments, further comprising a stone trading crypto coin module that runs an to enable stone transactions to be conducted using a real stone backed crypto coin.

In some embodiments, the block-chained data enhances stone identity verification.

In some embodiments, said matching server is adapted to automatically match two or more listed stones when the stones are determined by the system to have substantial similarity, at least partially in accordance with one or more of the stone profile, the asking price, user profile, trading history data, and estimated price.

In some embodiments, the system further includes a stone visual verification module for enabling remote visual verification of a stone profile, for enabling cross verification between an original stone certification and system generated stone data.

In some embodiments, the system further includes a stone trading insurance module, wherein one or more of stone listing changes, stone sell requests, stone buy request changes, stone promotion changes, stone matching changes, and stone verification changes may be automatically calculated as part of a stone trade insurance proposal to be made available for purchase by system users.

According to some embodiments, a stone trading platform is provided, that includes: a database including a listing of multiple users' profiles; a database including a listing of a users' stones for offer; a database including a listing of the users' stones being requested; a database including a listing of actual deal prices for stones that have been previously traded; and a database including a listing of the trading history of the users' stones for offer and/or the user's stones being requested; wherein the database is cloud computing compatible, and wherein the actual deal prices and the listing of the trading history of the users' stones for offer and/or the user's stones being requested are stored in a blockchain.

In some embodiments, the platform further includes a cloud computing compatible server including an algorithm for calculating one or more of personal stone trading report(s), indications of exposure of the user's stones, actual deal prices (ADP) of user's stones or other substantially similar stones, community generated feedback, user grading data, deal history data, market analysis data on user's stones or other substantially similar stones, stone pedigree data, and stone trading history data on user's stones or other substantially similar stones.

In some embodiments, the platform further includes a visual verification module for enabling cross verification between an original stone certification and platform generated stone data.

In some embodiments, the platform further includes stone trading insurance module, wherein one or more of stone listing changes, stone sell requests, stone buy request changes, stone promotion changes, stone matching changes, and stone verification changes may be automatically calculated as part of a stone trade insurance proposal to be made available for purchase by platform users.

According to some embodiments, an online stone trading method is provided, that includes: listing one or more stones available for sale on a cloud computing compatible database, said stones being listed with a stone profile and an asking price; listing one or more stones being requested for purchase, on the cloud computing compatible database, by a potential buyer; executing a pricing algorithm for calculating the real time estimated pricing of the listed stones, on a server; executing a matching algorithm for matching stone listings to stone buy requests, at least partially in accordance with the asking price and the stone profile, on the server; and storing the real time estimated pricing of the listed stones in a blockchain, for enabling stone trading verification by multiple users of the cloud computing compatible database.

In some embodiments, the method further includes listing one or more previous actual deal prices.

In some embodiments, the method further includes executing a stone valuation algorithm, for enabling automated valuing of stones in relation to stone characteristics, stone selling price and real demand prices.

In some embodiments, the method further includes a step of automatically creating paired stones substantially in real time.

In some embodiments, the method further includes automatically sending list changes to a user.

In some embodiments, the method further includes adding one or more of stone listing changes, stone sell requests, stone buy request changes, stone promotion changes, stone matching changes, and stone verification changes to the database, and running an insurance stone trading algorithm to calculate an insurance proposal for a stone trade.

In some embodiments, the method further includes running code for calculating stone trading related data to provide a crypto coin stone value that enables stone transactions to be conducted using a real stone backed crypto coins or parts thereof.

In some embodiments, the method further includes photographing a stone by a seller holding said stone; and executing a stone verification algorithm, for enabling remote cross verification between an original stone certification data and data generated by an online stone trading system.

### BRIEF DESCRIPTION OF THE DRAWINGS

The principles and operation of the system, apparatus, and method according to the present invention may be better understood with reference to the drawings, and the following description, it being understood that these drawings are given for illustrative purposes only and are not meant to be limiting, wherein:

FIGS. 1A and 1B are schematic diagrams showing components of a diamond trading platform, according to some embodiments;

FIG. 2 is a flowchart illustrating a series of diamond trading verification processes, in accordance with some embodiments;

FIG. 3 is a flowchart illustrating a series of diamond trading valuation processes, in accordance with some embodiments;

FIG. 4 is a flowchart illustrating a series of diamond brokering processes, in accordance with some embodiments;

FIG. 5 is a schematic diagram showing an example of the community functionality in a diamond trading platform, according to some embodiments; and

FIG. 6 is a screenshot showing an example of a transaction insurance interface, showing an example of variable that can be processed to determine an insurance price for a transaction, in some examples.

It will be appreciated that for simplicity and clarity of illustration, elements shown in the drawings have not necessarily been drawn to scale. For example, the dimensions of some of the elements may be exaggerated relative to other elements for clarity. Further, where considered appropriate, reference numerals may be repeated among the drawings to indicate corresponding or analogous elements throughout the serial views.

### DETAILED DESCRIPTION OF THE INVENTION

The following description is presented to enable one of ordinary skill in the art to make and use the invention as provided in the context of a particular application and its requirements. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In other instances, well-known methods, procedures, and components have not been described in detail so as not to obscure the present invention.

The term “diamond trading platform” as used herein may encompass platforms for trading in other products, stocks, metals, materials etc. The word “stone” as used herein refers generally to diamonds, but may also encompass other precious stones, rocks, or other trade-able materials, objects or products.

Embodiments of the present invention enable execution of a cross platform diamond trading platform, including electronic (e.g., online, mobile, tablet) diamond verification, diamond promotions, diamond portfolio management, diamond valuations and more.

According to some embodiments, a platform, system and method are herein provided to enable enhanced stone trading, the system including a stone listings data storage means, at least some of the stones being listed with a stone profile and a sell asking price; a stone buy requests data storage means; at least one pricing server including a pricing algorithm for calculating the real time estimated pricing of the listed stones; and at least one matching server including a matching algorithm for matching stone listings to stone buy requests, at least partially in accordance with the real time estimated pricing, wherein at least one of the stone listing data storage means, stone buy requests data storage means, the pricing server or the matching server are cloud computing compatible.

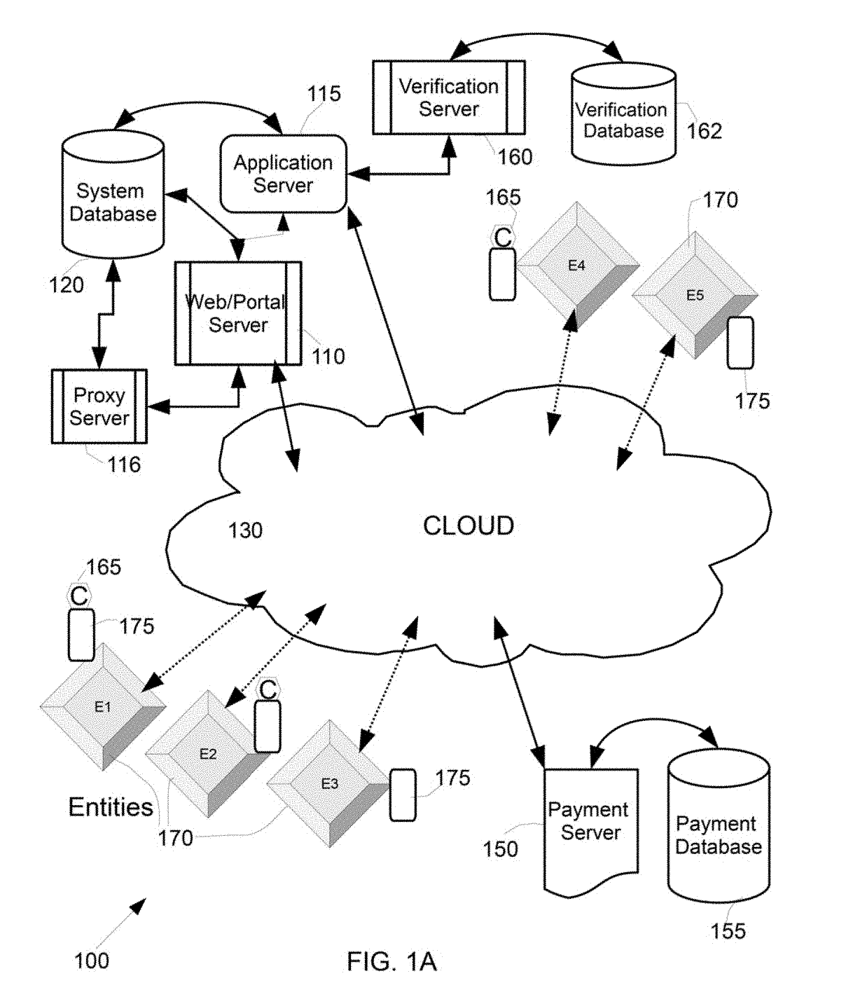

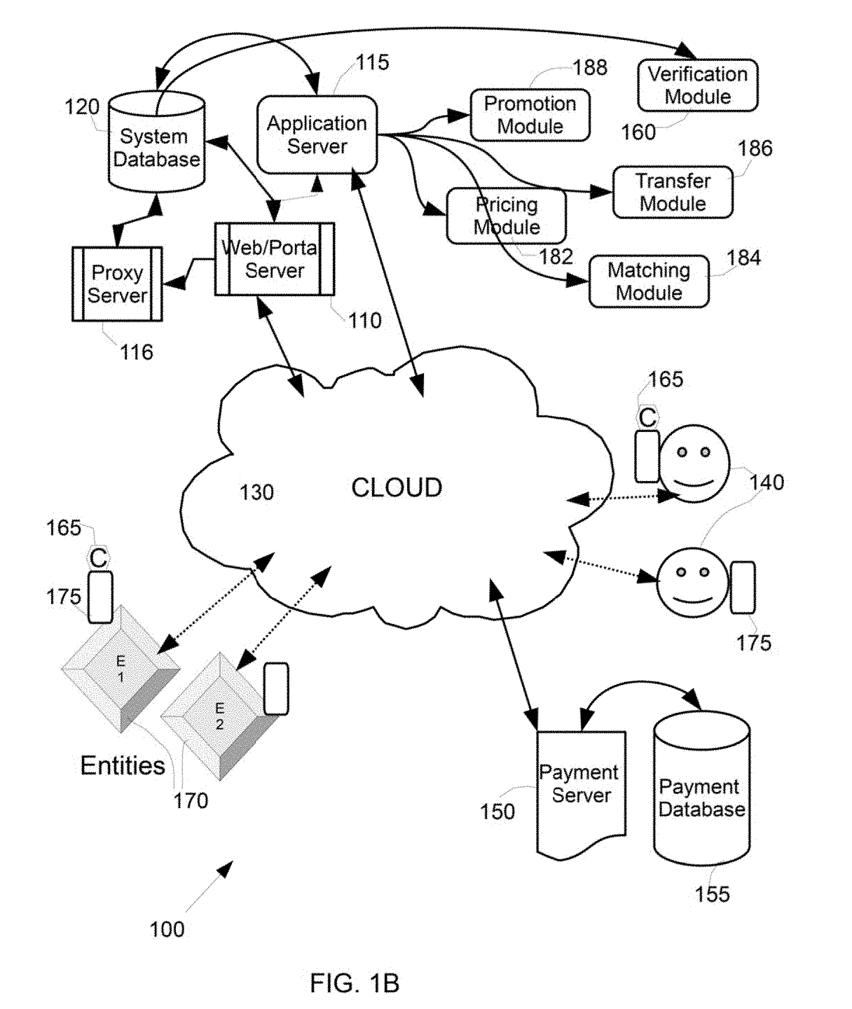

Reference is now made to FIG. 1A, which is a schematic block diagram illustration of components of an example of a diamond trading system 100, according to some embodiments. As can be seen in FIG. 1A, the system may include a Web or portal server 110, for running code to enable management of the diamond trading system; Application server 115, for running code to enable management of the diamond trading application; Proxy server 116, to allow sending and receiving of push notification messages for the mobile users, and other functions; System database or data storage means 120, for storing and processing system related data; a data or communications cloud 130, such as the Internet or an Intranet, for communicatively connecting system users and elements, wirelessly or via cable or other communication means. System 100 may further include a payment server 150, for running code to enable management of the diamond trading related payments; and a payment database 155, for storing and processing payment related data for storing and processing system related data. In some embodiments, system 100 may include external interfaces to external service providers, such as shipment company servers etc. Further, system 100 may include an interface to local ERP systems or other user modules or elements, as may be used by the system users.

System 100 may further include a verification module 160, for example a visual verification module, for running code to enable diamond authenticity verification, in association with digital cameras\microscopes 165; and a verification database 162, for storing and processing diamond verification related data. In some embodiments verification module 160 may enable diamond verification, deal verification and/or user verification. System 100 may further include multiple users 170, typically equipped with a communications or computing device 175, and optionally a digital camera device 165. In some embodiments users 170 may be users with full or partial access to system functions. In one example users 170 may be diamond brokers, companies, institutions etc. Camera devices 165 may be web cams, digital cameras, microscopes, digital microscopes, communication device cameras, or special function cameras. In some examples cameras may be high resolution magnification cameras or other scanning or photography device for photographing, videoing or otherwise capturing diamond features, details, colors, etc. In some embodiments verification module 160 may enable diamond verification, data verification, deal verification and/or user verification, for example, using camera 165 to scan, photograph or video a diamond, location, person etc. to aid other users in verifying data. In one embodiment a verification module for non-mobile users is provided, hereinafter referred to as “Eloupe”. In another embodiment a verification module for mobile users is provided, hereinafter referred to as “Mloupe”. Mloupe may be run through, for example, an Application that provides a dedicated visual verification application for stones, installed on Smartphone's and tablets. In further embodiments such mobile Applications may integrate augmented reality technology. In additional embodiments such mobile Applications may integrate enhanced trading features, including push notification messages, to help promote trade.

System 100 may further include a media server, transfer server, ERP module, and/or additional or alternative modules for providing additional functionality to web server 110, proxy server 116 and/or application server 115. Of course, other functions or combinations of functions may be provided.

In some embodiments communications devices 175 may be desktop, mobile or other computing devices, for example, smart phones, tablet devices, notebook devices, desk top devices, or other application supporting communication or computing devices, whether cable or wireless based devices. Devices 175 must be enabled to install and run applications, and in particular a diamond trading application s described below. Devices 175 may include dedicated or generic applications, where these applications may be native mobile OS compatible. In other examples, devices 175 may be generic web based application add-ons, plug-ins or programs., enabling devices 175 to fully interact with System 100. System 100 may further include multiple entities 170, typically equipped with a communications or computing device 175, and optionally a digital camera device 165. In some embodiments entities 170 may be users with full or partial access to system functionalities. In one example entities 170 may be diamond buyers, diamond sellers, diamond professionals or diamond consumers, or uses with other related tasks. Entities may also be equipped with camera devices 165. In some examples cameras may be high resolution magnification cameras or other scanning or photography device for photographing, videoing or otherwise capturing diamond features, details, colors, etc. Of course, other structures and dimensions may be used. Visual verification module 160 may include algorithms or code for analyzing images using picture analysis or other mathematical manipulations. In addition visual verification module 160 may include a general user interface allowing users to visually inspect a diamond using various features or functions, such as enlarge, crop, rotate, enhance, zoom etc. Verification module 160 may further be adapted to generate reports, for example, to report a diamond observation for other system users, entities etc.

In some embodiments, database 120 may include a listing of a users' stones for offer; a listing of a users' stones being requested; a listing of actual deal prices for stones that have been previously traded; and a listing of the trading history of a users' stones for offer and/or a user's stones being requested. In general, the database may be cloud computing compatible.

In some embodiments, as can be seen with reference to FIG. 1B, users 140, for example brokers, companies, institutions, businesses etc. may be included in system 100. Brokers, as defined herein, may be entities who do not own diamonds, but may facilitate diamond sales and purchases on behalf of sellers and buyers. In further embodiments, system 100 may include one or more of pricing module 182, to enable pricing estimates, reports, publications etc.; matching module 184, for enabling diamond buyers and sellers to be automatically matched; Transfer module 186, for enabling secure and reliable transfer of purchased diamonds from sellers to buyers; and Promotion module 188, for enabling pay for exposure (e.g., pay per click, pay per view) based and/or activity based promotions of diamonds to users of the system, optionally on an internal website or GUI of the system or platform, and/or one or more external websites or GUI's.

As can be seen in FIG. 1B, system 100 may further include a media server 117, transfer server 118, ERP module 119, for providing additional functionality to web server 110, proxy server 116 and/or application server 115. Of course, other functions or combinations of functions may be provided.

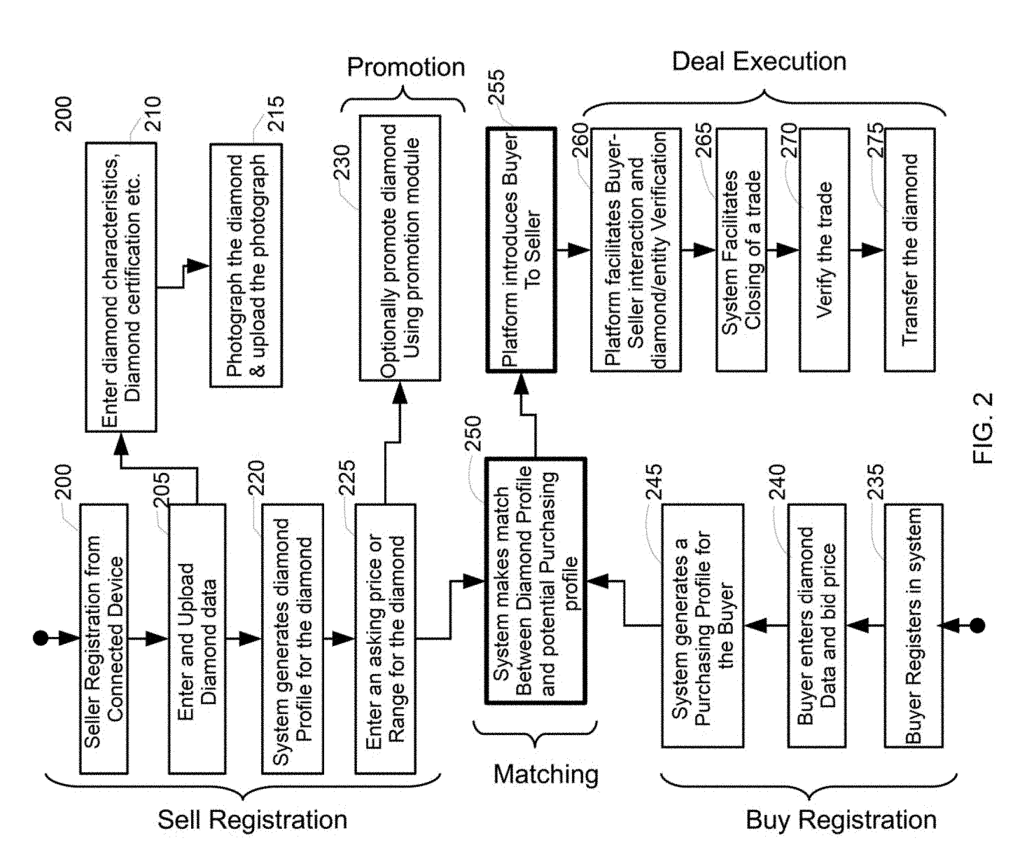

FIG. 2 schematically illustrates a series of operations or processes that may be implemented to enable online diamond trading, according to some embodiments. As can be seen in FIG. 2, the Sell Registration phase may include one or more of the following steps: At step 200 a seller may register in the system, using any Internet connected device. At step 205 the seller enters diamond data and uploads the data. As can be seen in step 210, entry of diamond data may include entry of diamond characteristics, for example, size, color, shape, design, strengths, weaknesses, asking price or price range, place of origin etc., and diamond certification(s). Further, in step 215, seller may enter diamond photograph, video or views etc., optionally using a camera device 165. In some examples the seller may photograph common or exceptional views, angles, perspectives etc., optionally using specialized high resolution lenses. At step 220 the system generates a diamond profile, for each diamond entered into the system. At step 225 the user may post his or her buy request. In some examples, the system may expose the seller's buy request in accordance with the seller's relevant diamond stock, to enhance matching accuracy and relevance. At step 230, the seller may choose to promote the diamond, as is described below in detail.

As can be seen in FIG. 2, the Buy Registration phase may include one or more of the following steps: At step 235 a buyer may register in the system, using any Internet connected device. At step 240 the buyer enters diamond data for required diamond(s), including a bid or buy price or range for which they are prepared to buy a diamond or portfolio of diamonds. At step 245 the system generates a purchasing profile, for the buyer, optionally including one or more diamonds being wanted for purchase.

As can be seen in FIG. 2, the User Matching phase may include one or more of the following steps: At step 250 the system runs a matching code or algorithm to intelligently match a diamond profile(s) with a purchasing profile(s), to automatically generate relevant connections between diamonds offered and diamonds wanted. At step 255 the system introduces the buyer and the seller, on the basis of the matching algorithm, thereby enabling the potential buyer and seller to continue the deal making or communication.

As can be seen in FIG. 2, the User Matching phase may include automatically matching the existing buy requests posted in system 100 (potential purchasing profile) to the user's uploaded stock, displaying only relevant buy requests to the users.

As can be seen in FIG. 2, the Deal Execution phase may include one or more of the following steps: At step 260 the system may provide elements to enable buyer-seller interaction, for example, messaging, contact data, audio and/or video conferencing, or other means for facilitating communication between system users. At step 265, the system facilitates closing of a deal, for example, by allowing bids to be refined, changes, discussed, negotiated, verified, confirmed etc. At step 270 the deal may be verified, for example, using a verifying module to verify diamond and/or the users involved. At step 275 the diamond may be transferred from the seller to the buyer, optionally using one or more transfer verification elements, shipment options, handling options etc.

According to some embodiments, online diamond promotion, at step 230, may include seller actively electing to promote a diamond or portfolio of diamonds, using paid promotion and/or active promotion. In one example, paid promotion may include selecting a promotion package or schedule for promoting a diamond. In some examples exposure or position type promotion may be used, which will place the diamond higher on a search results list, in a more prominent position, or in an enhanced format, in accordance with, for example, the diamond price, the traders status (e.g., whether they are colleagues or not) and the average rank of the users etc. Other promotional strategies or packages may additionally or alternatively be used, such as paid promotion using banners, icons, messaging, enhanced formatting, pay for clicks, pay for views, or other means. The promotion module 188 may further facilitate cross platform promotion reflecting the diamonds trade via all interfaces in system 100, for example, online websites, mobile devices (e.g., via general or dedicated Apps) and/or tablet devices. In further embodiments promotions may be activated via one or more promotion channels, such as, for example, a Generic channel that displays promoted stones to all logged in users, a Targeted channel that displays promoted stones per users preference, and/or a combination of both channels. Of course, other channels or combinations of channels may be used. In one example, the display order of the stones in the targeted channel(s) may be based on one or more of: stone prices, average grading of the user, whether the user is an approved “colleague”, stone rating, exposure of the stone etc.

Online diamond verification 260, according to some embodiments, may include, at various stages of interaction between system users, a verification request of the diamond and/or of the seller. In some examples, a buyer may request a visual verification of a diamond, and may ask the seller to photograph or video the diamond, optionally in real time, to allow the buyer to view the diamond. In a further example, buyer may request of seller to view the diamond, optionally using a high resolution lens device, in accordance with specific buyer instructions, to enable remote verification by the potential buyer, as if they were studying the diamond themselves. The on-line visual verification process may be executed via visual verification module 160 and a corresponding data server, such as a media server module (not shown in the figures).

According to some embodiments, a method of trading stones online is provided, which may include: listing one or more stones available for sale on a cloud computing compatible database, where the stones may be listed with a stone profile and a sell request price; listing one or more stones being requested for purchase, on the cloud computing compatible database, by a buyer; executing a pricing algorithm for calculating the real time estimated pricing of the listed stones, on a cloud computing compatible server; and executing a matching algorithm for matching stone listings to stone requests, at least partially in accordance with the real time estimated pricing, on the server. In some cases, the listing may also include one or more previous Actual Deal Prices (ADP).

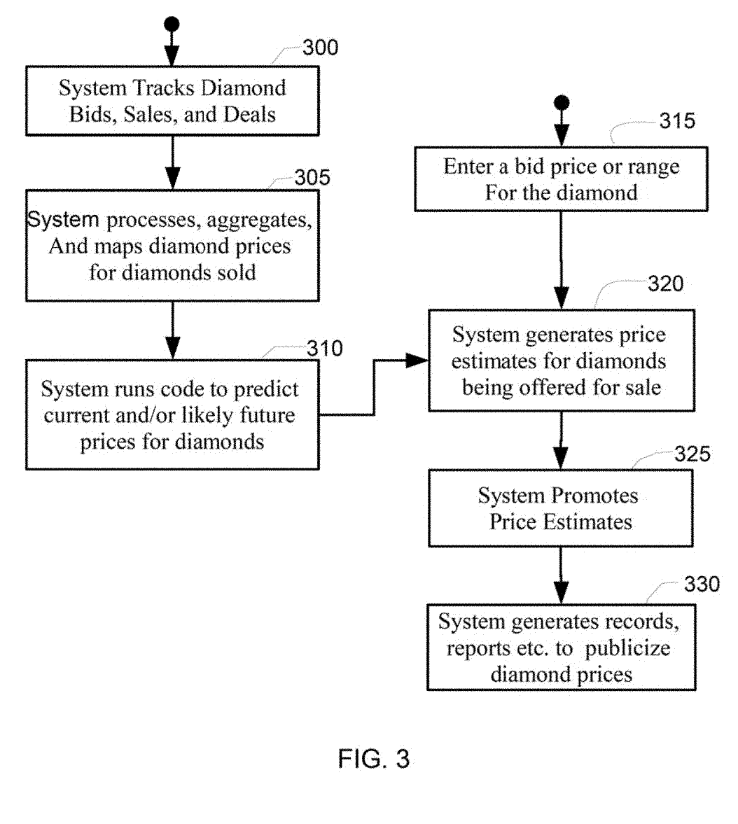

According to some embodiments, automated diamond valuations may be enabled. In some examples, diamond valuations may be based on ADP. In some examples, as can be seen in FIG. 3, the system may track all diamond deals closed, and/or diamond bids, at step 300. At step 305, the system may run code to process, aggregate, map etc. diamond prices for diamonds sold. At step 310 the system may run code to predict current and/or likely future prices for diamonds, in accordance with processing of diamond deal data. At step 315, a potential buyer or interested party may enter a diamond, for which he or she wants a price estimate. In accordance with the price request from 315, and in accordance with the prediction code run in 310, the system may generate price estimates for diamonds being offered for sale, at step 220. At step 325, the system may promote the price estimates, by default and/or upon request, with the diamonds being offered for sale. At step 330 the system may generate records, reports etc. to optionally publicize diamond prices.

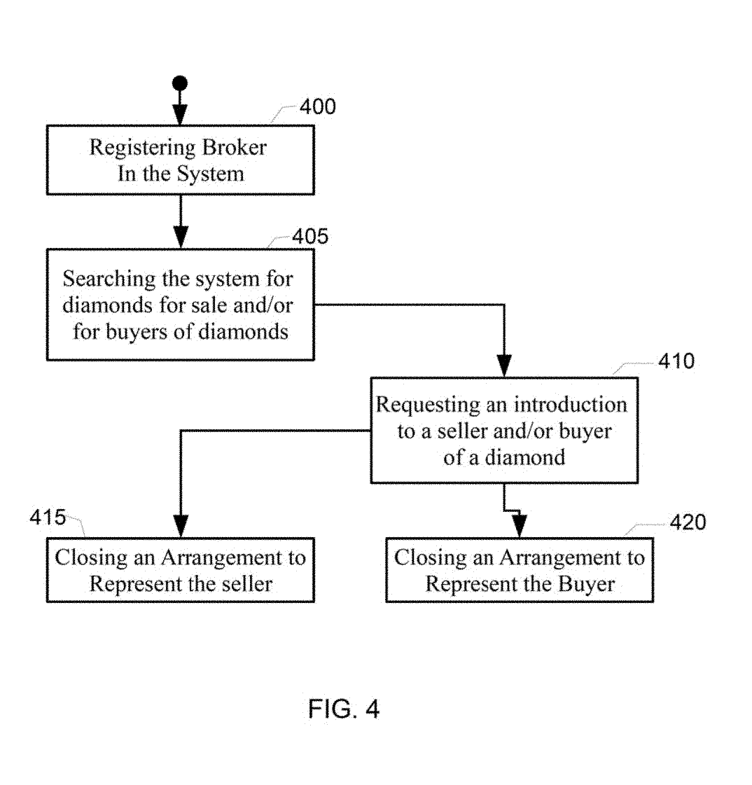

FIG. 4 schematically illustrates a series of operations or processes that may be implemented to enable diamond sales brokering, according to some embodiments. As can be seen in FIG. 4, at step 400 a sales broker may register with the system. At step 405 the broker may search the system for diamonds for sale and/or for buyers of diamonds. At step 410 the broker may request an introduction to a seller of a diamond, and/or at step 420 the broker may request an introduction to a buyer and/or a seller. At step 415 the broker may close an arrangement or deal to represent the seller, or likewise at step 420 to represent the buyer. Such arrangements may optionally include contractual elements, money arrangements, etc. In some embodiment, system 100 may provide full transparency for both sides (e.g., company & broker) in accordance, for example, to the assigned stones to the broker. Any combination of the above steps may be implemented.

According to some embodiments, various elements and processes may be implemented to enable advanced diamond network management. Users of the platform may form one or more online communities, allowing users to develop connections, create or join groups etc. In some examples, such communities may be set up as global communities or private business/social communities, wherein for example, trusted associates only may be allowed in ones group. In some embodiments users may provide ratings, points, comments, review etc. for other users, to enable development of trust relationships, provision of a scale of reliability etc. In some embodiments, the community module may enable users to create their own business community in order to establish trade relationships. In one example, once two users are acknowledged as colleagues (friends) by the system 100, the system may prioritize both user's stock when displaying any search results for posted buy requests and/or promoted stones to each other. In another example, the user's rating (e.g., scores given by other users to a first user, such as for honesty, reliability, service level etc.) in system 100 may have an effect on the users trade, for example, when a user's rating directly impacts on a promotion activity, by prioritizing the stock promoted by the users with the leading ratings, displaying them in more strategic position.

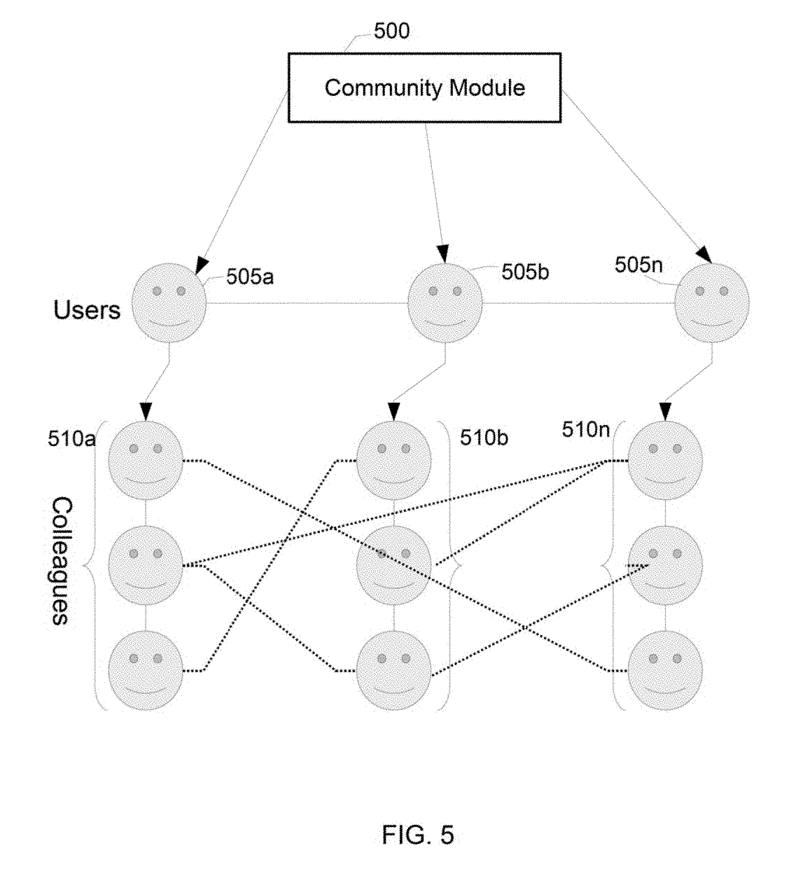

As can be seen with reference to FIG. 5, a community module 500 may facilitate the interaction between multiple users 505a, 505b and 505n. Further, each user may develop a network of colleagues 510a, 510b and 510n respectively, where each colleague may subsequently connect with other colleagues in other networks, in accordance with platform policies. According to some embodiments, colleagues and users may provide comments, scores, rankings etc. for other system users, the results of which may feature on system searches, matches, profiles etc. For example, if user 505a was ranked for reliability as a high 95% by his or her network, this rank may be viewable by other system users considering trading or otherwise corresponding with 505a. In a further example, user 505b may be ranked by his or her extended network, such as 510a and 510n. If user 505b were to receive a low service ranking of 35%, by the extended network, then this data may be available to users considering trading or otherwise cooperating with user 505b. Of course, other data aspects or combinations of aspects may be used. Further, data may be limited to selected users, paying users, selected groups etc.

In accordance with some embodiments, the diamond trading platform may enable advanced user search features, for desktop and mobile devices. In one example, buyers may categorize diamonds for sale using multiple diamond related fields. Similarly, sellers may categorize diamonds requested using multiple diamond related fields. The platform may run matching algorithms and filtering algorithms to enable rapid accurate matching of diamonds for sale and requests for purchase. Furthermore, platform users may search for diamonds and/or users using general searches, category searches or other filtering mechanisms, to allow users to access substantially real time diamond trade information from anywhere, at all times. According to some embodiments, the platform may facilitate advanced research features, in accordance with user behavior and/or user characteristics. In one example, the matching algorithm may incorporate user offer data, such that user sale data may be used to help generate filtered user request guidelines.

In some embodiments, a trade segmentation module including a private trade area according to personal profile is provided, whereby the system provides user or entity relevant data only, relating to users personal history, defined preferences etc. In some cases a user may invite one or more other users into their private trade area, which may be managed by the user.

In accordance with one embodiment, a diamond Matching Mechanism is provided, for enabling automated matching of pairs or groups of stones. For example, the system may automatically identify two or more stones that are substantially similar, or complimentary, such that matched stones may be offered to a buyer or seller to benefit from the “twin-stones” effect, thereby enabling the offer to reflect the combination of stones.

In accordance with some embodiments, a blockchain empowered diamond trading system 100 is provided, to enable a growing list of diamond transaction related records, or blocks, to be cryptographically linked, based on timestamp, transaction data etc. The integration in the diamond trading system of a diamond transaction blockchain services to make the transaction data resistant to modification, by using the open, distributed ledger to record transactions between parties efficiently and in a verifiable and permanent way.

For example, elements of the diamond exchange data core commercial data, sales prices, party data, diamond data etc. are written into the blockchain, thereby maintaining an authentic and verifiable record of the history of commercial transactions on the exchange and beyond. Such a system is designed to provide users with transaction support, backup, verification, authentication etc., thereby enhancing fair trade and trading safety.

In accordance with some embodiments, a crypto coin system, algorithm and method is provided, to enable diamond transactions to be conducted using a real diamond backed virtual or cryptic coin or currency.

In some embodiments, Data of actual bid price (ABP) and/or actual sales process, that are recorded on the exchange, and optionally recorded in a blockchain, are used to form a value of a diamond trading coin based on the real value of sales. For example, a formula or algorithm is applied to diamond sale related data, to generate a value per weight of a multiple diamond categories, to be used to support a crypto coin backed by actual diamond assets.

In one example, multiple sales of diamonds in a selected category may be added and aggregated to form an average value per weight, for example a value per 0.1 carrot of a specified stone category (shape, quality, etc.), such that such a volume of diamond in the category may be worth X $US, which is equivalent to X coins or parts of coins.

In accordance with some embodiments, a diamond cross verification mechanism is provided, for enabling cross verification between original diamond certification and exchange data. For example, every stone entered into the diamond exchange is captured as an image that is digitally analyzable, to detect and map defects, characteristics, qualities etc. The system described above includes hardware and software tools to analyze the graphic images to generate diagrams or computer-generated images and meta data that includes value indications that are checked against actual stone certifications. If accurate matches are determined, the stones are provided with a layer of authenticity that the actual stones being traded are the same ones as described in the declared certification.

In accordance with some embodiments, a diamond trading insurance system and method are provided, for enabling application of trade insurance for multiple or single diamonds traded on the exchange. For example, an insurance algorithm is run on the diamond related data that processes multiple trade related data fields (eg. diamond trade value, trade history, user history, trade risk, user credit etc., to generate a price or price range for insuring a sale of a diamond or group of diamonds. For example, a buyer choosing to sell diamonds on a consignment basis provides a risk to a seller that the sale will be made and compensated appropriately. The diamond trading insurance system described herein is executed to calculate the risk level and value of a trade, and is adapted to generate an insurance price, for example, for various time intervals, stone values, etc.

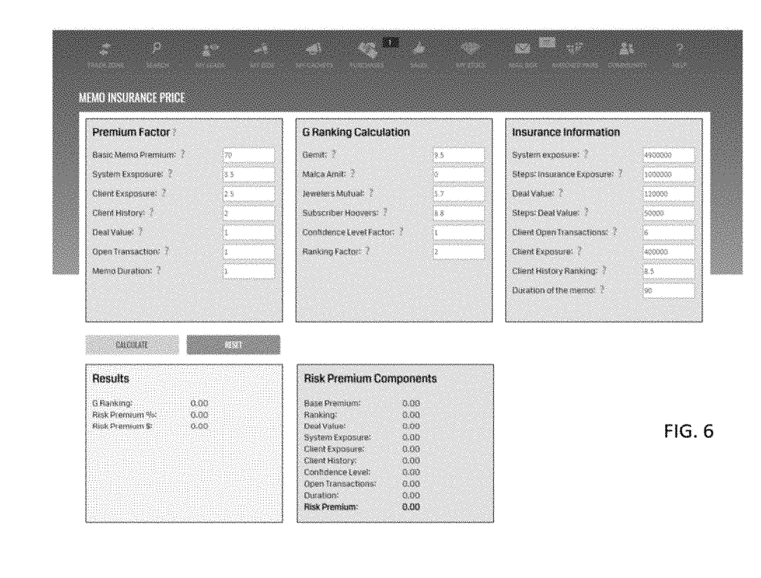

FIG. 6 is a screenshot showing an example of a transaction insurance interface, showing an example of variable that can be processed to determine an insurance price for a transaction, in some examples. As can be seen, an insurance calculation may be made for any transaction, based on one or more of the transaction related data fields shown.

The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

What is claimed is:

1. A blockchain powered stone trading system comprising:
a stone listings data storage means, at least some of said stones being listed with a stone profile and an asking price;
a stone buy requests data storage means;
at least one pricing server including a pricing algorithm for calculating the real time estimated pricing of said listed stones; and
at least one matching server including a matching algorithm for matching stone listings to stone buy requests;
wherein at least one of the stone listing data storage means, stone buy requests data storage means, the pricing server or the matching server are cloud computing compatible,
and wherein said stone listings, said buy requests and said real time estimated pricing are block-chained to enable transaction data to be resistant to modification.

2. The system of claim 1, wherein at least some of said stones may list an actual deal price.

3. The system of claim 1 further comprising a stone trading crypto coin module that runs an to enable stone transactions to be conducted using a real stone backed crypto coin.

4. The system of claim 1, wherein said block-chained data enhances stone identity verification.

5. The system of claim 1, wherein said matching server is adapted to automatically match two or more listed stones when said such stones are determined by the system to have substantial similarity, at least partially in accordance with one or more of said stone profile, said asking price, user profile, trading history data, and estimated price.

6. The system of claim 1, further comprising a stone visual verification module for enabling remote visual verification of a stone profile, for enabling cross verification between an original stone certification and system generated stone data.

7. The system of claim 1, further comprising a stone trading insurance module, wherein one or more of stone listing changes, stone sell requests, stone buy request changes, stone promotion changes, stone matching changes, and stone verification changes may be automatically calculated as part of a stone trade insurance proposal to be made available for purchase by system users.

8. A stone trading platform comprising:
a database including a listing of multiple users' profiles;
a database including a listing of a users' stones for offer;
a database including a listing of said users' stones being requested;
a database including a listing of actual deal prices for stones that have been previously traded; and
a database including a listing of the trading history of said users' stones for offer and/or said user's stones being requested;
wherein the database is cloud computing compatible,
and wherein said actual deal prices and said listing of the trading history of said users' stones for offer and/or said user's stones being requested are stored in a blockchain.

9. The platform of claim 8, further comprising a cloud computing compatible server including an algorithm for calculating one or more of personal stone trading report(s), indications of exposure of said user's stones, actual deal prices (ADP) of user's stones or other substantially similar stones, community generated feedback, user grading data, deal history data, market analysis data on user's stones or other substantially similar stones, stone pedigree data, and stone trading history data on user's stones or other substantially similar stones.

10. The platform of claim 8, further comprising a visual verification module for enabling cross verification between an original stone certification and platform generated stone data.

11. The platform of claim 8, further comprising a stone trading insurance module, wherein one or more of stone listing changes, stone sell requests, stone buy request changes, stone promotion changes, stone matching changes, and stone verification changes may be automatically calculated as part of a stone trade insurance proposal to be made available for purchase by platform users.

12. A method of trading stones online, comprising:
listing one or more stones available for sale on a cloud computing compatible database, said stones being listed with a stone profile and an asking price;
listing one or more stones being requested for purchase, on said cloud computing compatible database, by a potential buyer;
executing a pricing algorithm for calculating the real time estimated pricing of said listed stones, on a server;
executing a matching algorithm for matching stone listings to stone buy requests, at least partially in accordance with said asking price and said stone profile, on said server; and
storing said real time estimated pricing of said listed stones in a blockchain, for enabling stone trading verification by multiple users of the cloud computing compatible database.

13. The method of claim 12, where the listing may also include one or more previous actual deal prices.

14. The method of claim 12, further comprising executing a stone valuation algorithm, for enabling automated valuing of stones in relation to stone characteristics, stone selling price and real demand prices.

15. The method of claim 12, further comprising a step of automatically creating paired stones substantially in real time.

16. The method of claim 12, comprising automatically sending list changes to a user.

17. The method of claim 15, comprising adding one or more of stone listing changes, stone sell requests, stone buy request changes, stone promotion changes, stone matching changes, and stone verification changes to the database, and running an insurance stone trading algorithm to calculate an insurance proposal for a stone trade.

18. The method of claim 12, further comprising running code for calculating stone trading related data to provide a crypto coin stone value that enables stone transactions to be conducted using a real stone backed crypto coins or parts thereof.

19. The method of claim 12, further comprising:
photographing a stone by a seller holding said stone; and
executing a stone verification algorithm, for enabling remote cross verification between an original stone certification data and data generated by an online stone trading system.

20. The method of claim 12, further comprising:
promoting one or more selected stones on one or more promotion platforms using a pay for exposure type promotion methodology, on an internal or external websites.
